(19) United States
(12) Patent Application Publication
(10) Pub. No.: US 2020/0342754 A1
(43) Pub. Date: Oct. 29, 2020

(54) CIRCULAR INTERSECTION NOTIFICATION DEVICE, CIRCULAR INTERSECTION NOTIFICATION SYSTEM, AND CIRCULAR INTERSECTION NOTIFICATION METHOD

(71) Applicant: Mitsubishi Electric Corporation, Tokyo (JP)

(72) Inventor: Shusuke NAKAMURA, Tokyo (JP)

(73) Assignee: Mitsubishi Electric Corporation, Tokyo (JP)

(21) Appl. No.: 16/960,781

(22) PCT Filed: Feb. 14, 2018
(86) PCT No.: PCT/JP2018/005068

§ 371 Date: Jul. 8, 2020

(51) Int. Cl. G08G 1/0967; G08G 1/0962; G06N 5/04

(52) U.S. Cl. CPC G08G 1/0967; G06N 5/04; G08G 1/09626

(57) ABSTRACT

A circular intersection notification device (100) includes: an experience value calculating unit (27) to calculate an experience value of the number of times of passage through a circular intersection or the number of times of notification of an approach to a circular intersection by counting the number of times of passage or the number of times of notification; an experience value determining unit (24) to, when a vehicle (1) approaches a to-be-passed-through circular intersection, determine whether the experience value calculated by the experience value calculating unit (27) is less than a threshold value; and a second notification controlling unit (25) to, when the experience value determining unit (24) determines that the experience value is less than the threshold value, perform control to notify a user currently driving the vehicle (1) of traffic rules at the to-be-passed-through circular intersection.

### TECHNICAL FIELD

The present disclosure relates to a circular intersection notification device, a circular intersection notification system, and a circular intersection notification method.

### BACKGROUND ART

Conventionally, a technique for, in a case in which when a vehicle approaches a circular intersection (a so-called “roundabout”), there is a difference between the traffic rules at circular intersections in an area (referred to as a “first area” hereinafter) including the current position of the vehicle and those at circular intersections in the driver's residence area (referred to as a “second area” hereinafter), notifying the driver of the traffic rules at the circular intersections in the second area has been developed (for example, refer to paragraph [0062] and so on of Patent Literature 1).

### CITATION LIST

### Patent Literature

Patent Literature 1: WO 2012/172675

### SUMMARY OF INVENTION

### Technical Problem

In a conventional technology as described in Patent Literature 1, when the traffic rules at the circular intersections in the second area are the same as those at the circular intersections in the first area, no notification of the traffic rules at circular intersections is provided.

However, for example, in a case in which the number of circular intersections constructed is small in any of the first and second areas, there is a possibility that the user currently driving the vehicle does not have much experience in driving through circular intersections. Accordingly, there is a possibility that the user does not know the traffic rules at circular intersections in both the areas, irrespective of whether or not there is a difference between the traffic rules at the circular intersections in the first area and those at the circular intersections in the second area. In such a case, it is preferable to notify the user of the traffic rules at circular intersections irrespective of whether or not there is a difference between the traffic rules at the circular intersections in the first area and those at the circular intersections in the second area.

The present disclosure is made in order to solve the above-described problem, and it is therefore an object of the present disclosure to provide a circular intersection notification device, a circular intersection notification system, and a circular intersection notification method capable of notifying users who do not have much experience in driving through a circular intersection of the traffic rules at the circular intersection.

### Solution to Problem

A circular intersection notification device of the present invention includes: an experience value calculating unit to calculate an experience value of either the number of times of passage through a circular intersection or the number of times of notification of an approach to a circular intersection by counting the number of times of passage or the number of times of notification; an experience value determining unit to, when a vehicle approaches a to-be-passed-through circular intersection through which the vehicle is presumed to pass through, determine whether or not the experience value calculated by the experience value calculating unit is less than a threshold value; and a notification controlling unit to, when the experience value determining unit determines that the experience value is less than the threshold value, perform control to notify a user currently driving the vehicle of traffic rules at the to-be-passed-through circular intersection.

### Advantageous Effects of Invention

According to the present disclosure, because the circular intersection notification device is configured as above, a notification of the traffic rules at the circular intersection can be provided for users who do not have much experience in driving through the circular intersection.

### BRIEF DESCRIPTION OF DRAWINGS

FIG. 1 is a block diagram showing a main part of a control device including a circular intersection notification device according to Embodiment 1;

FIG. 2 is an explanatory drawing showing an example of a second notification image;

FIG. 3A is a block diagram showing a hardware configuration of the control device including the circular intersection notification device according to Embodiment 1;

FIG. 3B is a block diagram showing another hardware configuration of the control device including the circular intersection notification device according to Embodiment 1;

FIG. 4 is a flowchart showing the operation of the control device including the circular intersection notification device according to Embodiment 1;

FIG. 5 is a block diagram showing a main part of the control device including another circular intersection notification device according to Embodiment 1;

FIG. 6 is a flowchart showing the operation of the control device including the other circular intersection notification device according to Embodiment 1;

FIG. 7 is an explanatory drawing showing an example of a positional relationship between a user's home or place of work and a circular intersection;

FIG. 8A is a block diagram showing a main part of a control system including a circular intersection notification system according to Embodiment 1;

FIG. 8B is a block diagram showing a main part of a control system including a circular intersection notification system according to Embodiment 1;

FIG. 9A is a block diagram showing a system configuration of a control system including a circular intersection notification system according to Embodiment 1;

FIG. 9B is a block diagram showing another system configuration of the control system including the circular intersection notification system according to Embodiment 1;

FIG. 9C is a block diagram showing another system configuration of the control system including the circular intersection notification system according to Embodiment 1;

FIG. 9D is a block diagram showing another system configuration of the control system including the circular intersection notification system according to Embodiment 1;

FIG. 10 is a block diagram showing a main part of a control device including a circular intersection notification device according to Embodiment 2;

FIG. 11 is an explanatory drawing showing an example of a warning image;

FIG. 12 is a flowchart showing the operation of the control device including the circular intersection notification device according to Embodiment 2;

FIG. 13 is a block diagram showing a main part of a control device including another circular intersection notification device according to Embodiment 2;

FIG. 14 is a flowchart showing the operation of the control device including the other circular intersection notification device according to Embodiment 2;

FIG. 15A is a block diagram showing a main part of a control system including a circular intersection notification system according to Embodiment 2; and

FIG. 15B is a block diagram showing a main part of a control system including a circular intersection notification system according to Embodiment 2.

### DESCRIPTION OF EMBODIMENTS

Hereinafter, in order to explain the present disclosure in greater detail, some embodiments of the present disclosure will be described with reference to the accompanying drawings.

### Embodiment 1

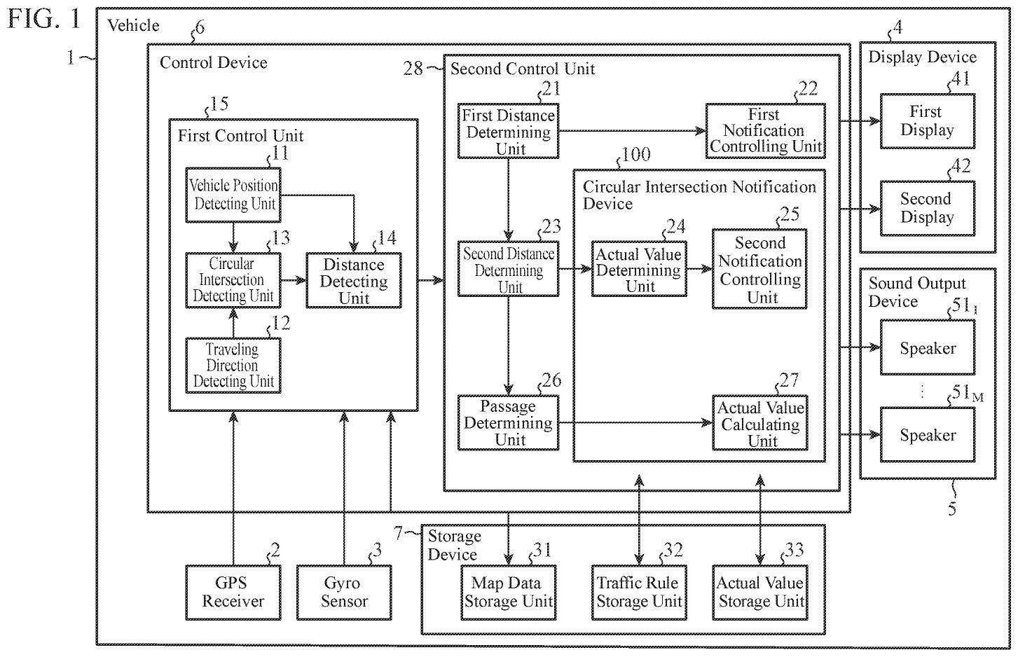

FIG. 1 is a block diagram showing a main part of a control device including a circular intersection notification device according to Embodiment 1. Referring to FIG. 1, the circular intersection notification device 100 of Embodiment 1 will be explained focusing on an example in which the circular intersection notification device is disposed in the control device 6 in a vehicle 1.

A vehicle position detecting unit 11 detects the current position of the vehicle 1 (referred to as the “vehicle position” hereinafter) by using global navigation satellite system (GNSS) signals by means of a so-called “satellite navigation system.” These GNSS signals include, for example, output signals outputted by a global positioning system (GPS) receiver 2 disposed in the vehicle 1, i.e., GPS signals. The vehicle position detecting unit 11 generates information showing the detected vehicle position (referred to as the “vehicle position information” hereinafter).

A traveling direction detecting unit 12 detects the traveling direction of the vehicle 1 by using an output signal outputted by a sensor disposed in the vehicle 1. This sensor includes, for example, a gyro sensor 3. The traveling direction detecting unit 12 generates information showing the detected traveling direction (referred to as the “traveling direction information” hereinafter).

A circular intersection detecting unit 13 acquires map data stored in a map data storage unit 31. The circular intersection detecting unit 13 detects a circular intersection through which the vehicle 1 is presumed to pass through (referred to as a “to-be-passed-through circular intersection” hereinafter) by using the acquired map data, the vehicle position information generated by the vehicle position detecting unit 11, and the traveling direction information generated by the traveling direction detecting unit 12.

Concretely, for example, when a navigation system (not illustrated) for the vehicle 1 is showing a travel route of the vehicle 1, the circular intersection detecting unit 13 performs a process of detecting a circular intersection which is included in the travel route and through which the vehicle 1 has not passed yet (referred to as a “first detecting process” hereinafter). As an alternative, for example, when the navigation system (not illustrated) for the vehicle 1 is not showing any travel route of the vehicle 1, the circular intersection detecting unit 13 performs a process of detecting a circular intersection present in a predetermined range ahead of the vehicle 1 (referred to as a “second detecting process” hereinafter).

When one or more circular intersections are detected through the first detecting process or the second detecting process, the circular intersection detecting unit 13 sets the circular intersection closest to the vehicle position, out of the one or more circular intersections, as the to-be-passed-through circular intersection. The circular intersection detecting unit 13 generates information showing the position, the type, and so on of the set to-be-passed-through circular intersection. On the other hand, when no circular intersection is detected through the first detecting process or the second detecting process, the circular intersection detecting unit 13 determines that no to-be-passed-through circular intersection is present. The circular intersection detecting unit 13 generates information showing that no to-be-passed-through circular intersection is present.

Hereinafter, the information generated by the circular intersection detecting unit 13 is referred to as the “circular intersection information.” Namely, when a to-be-passed-through circular intersection is present, the circular intersection information shows the position, the type, and so on of the to-be-passed-through circular intersection, whereas when no to-be-passed-through circular intersection is present, the circular intersection information shows that no to-be-passed-through circular intersection is present.

The “type” of a circular intersection is classification based on, for example, the number of lanes at the circular intersection (one lane or multiple lanes), the traveling direction of the vehicle (clockwise rotation or counterclockwise rotation), and so on.

Hereinafter, the circular intersection detected by the circular intersection detecting unit 13, i.e., the to-be-passed-through circular intersection is denoted by a reference sign of “R” in some cases.

The distance detecting unit 14 detects the distance L between the vehicle 1 and the to-be-passed-through circular intersection R by using the vehicle position information generated by the vehicle position detecting unit 11 and the circular intersection information generated by the circular intersection detecting unit 13. The distance detecting unit generates information showing the detected distance L (referred to as the “distance information” hereinafter).

A first control unit 15 is constituted by the vehicle position detecting unit 11, the traveling direction detecting unit 12, the circular intersection detecting unit 13, and the distance detecting unit 14. The first control unit 15 has a function of outputting each of the following pieces of information: the vehicle position information, the traveling direction information, the circular intersection information, and the distance information to each unit in a second control unit 28 appropriately.

An experience value calculating unit 27 counts the number of times of passage of the vehicle 1 through a circular intersection to calculate an experience value N of the number of times of passage. The experience value calculating unit 27 causes an experience value storage unit 33 to store the calculated experience value N.

A threshold value Lth1 that is a value to be compared with the distance L is preset in a first distance determining unit 21. The first distance determining unit 21 acquires the distance information generated by the distance detecting unit 14. The first distance determining unit 21 determines whether or not the distance L is equal to or less than the threshold value Lth1 by using the acquired distance information.

When the first distance determining unit 21 determines that the distance L is equal to or less than the threshold value Lth1, a first notification controlling unit 22 performs control to notify the user currently driving the vehicle 1 that the vehicle 1 approached the to-be-passed-through circular intersection R.

Concretely, for example, the first notification controlling unit 22 performs at least one of control to cause a display device 4 to display an image showing that the vehicle 1 approached the to-be-passed-through circular intersection R (referred to as a “first notification image” hereinafter) and control to cause a sound output device 5 to output a sound showing that the vehicle 1 approached the to-be-passed-through circular intersection R (referred to as a “first notification sound” hereinafter).

The display device 4 is constituted by, for example, a first display 41 and a second display 42. The first display 41 is constituted by, for example, a liquid crystal display (LCD) or an organic electro luminescence display (OLED), and is disposed in the dashboard of the vehicle 1. The second display 42 is constituted by, for example, a head-up display (HUD) for the vehicle 1.

The sound output device 5 is constituted by, for example, M speakers 51₁ to 51_{M} (M is an integer equal to or greater than 1). The speakers 51₁ to 51_{M} are arranged in, for example, the vehicle cabin of the vehicle 1.

A threshold value Lth2 that is a value to be compared with the distance L is preset in a second distance determining unit 23. The threshold value Lth2 is set to be less than the threshold value Lth1. The second distance determining unit 23 acquires the distance information generated by the distance detecting unit 14 when the first distance determining unit 21 determined that the distance L is equal to or less than the threshold value Lth1. The second distance determining unit 23 determines whether or not the distance L is equal to or less than the threshold value Lth2 by using the acquired distance information.

A threshold value Nth that is a value to be compared with the experience value N is preset in an experience value determining unit 24. When the second distance determining unit 23 determines that the distance L is equal to or less than the threshold value Lth2, the experience value determining unit 24 acquires the experience value N stored in the experience value storage unit 33. The experience value determining unit 24 determines whether or not the acquired experience value N is less than the threshold value Nth.

Information showing traffic rules at each circular intersection (referred to as “traffic rule information” hereinafter) is stored in a traffic rule storage unit 32. When the experience value determining unit 24 determines that the experience value N is less than the threshold value Nth, a second notification controlling unit 25 acquires the traffic rule information showing the traffic rules at the to-be-passed-through circular intersection R from the traffic rule storage unit 32. The second notification controlling unit 25 performs control to notify the user currently driving the vehicle 1 of the traffic rules at the to-be-passed-through circular intersection R by using the acquired traffic rule information.

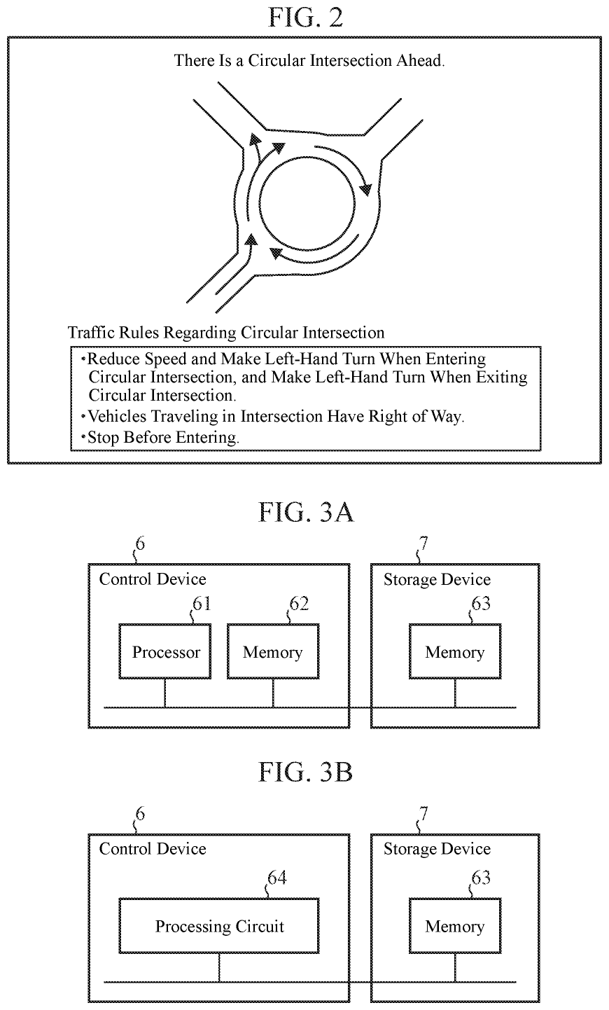

Concretely, for example, the second notification controlling unit 25 performs at least one of control to cause the display device 4 to display an image showing the traffic rules at the to-be-passed-through circular intersection R (referred to as a “second notification image” hereinafter) and control to cause the sound output device 5 to output a sound showing the traffic rules at the to-be-passed-through circular intersection R (referred to as a “second notification sound” hereinafter). FIG. 2 shows an example of the second notification image.

A passage determining unit 26 acquires the vehicle position information generated by the vehicle position detecting unit 11 and the circular intersection information generated by the circular intersection detecting unit 13 when the second distance determining unit 23 determined that the distance L is equal to or less than the threshold value Lth2. The passage determining unit 26 determines whether the vehicle 1 passed through the circular intersection R by using the acquired vehicle position information and the acquired circular intersection information.

Concretely, for example, when the vehicle 1 entered the circular intersection R and then exited the circular intersection R, the passage determining unit 26 determines that the vehicle 1 passed through the circular intersection R. On the other hand, when the vehicle 1 makes a right-hand turn, a left-hand turn, or a U-turn before the circular intersection R, thereby moving away from the circular intersection R without entering the circular intersection R, the passage determining unit 26 determines that the vehicle 1 did not pass through the circular intersection R.

When the passage determining unit 26 determines that the vehicle 1 passed through the circular intersection R, the experience value calculating unit 27 increments the experience value N. The experience value calculating unit 27 updates the experience value N stored in the experience value storage unit 33 by storing the incremented experience value N in the experience value storage unit 33.

The second control unit 28 is constituted by the first distance determining unit 21, the first notification controlling unit 22, the second distance determining unit 23, the experience value determining unit 24, the second notification controlling unit 25, the passage determining unit 26, and the experience value calculating unit 27. A main part of the circular intersection notification device 100 is constituted by the experience value determining unit 24, the second notification controlling unit 25, and the experience value calculating unit 27.

A main part of the control device 6 is constituted by the first control unit 15 and the second control unit 28. A main part of the storage device 7 is constituted by the map data storage unit 31, the traffic rule storage unit 32, and the experience value storage unit 33.

Next, the hardware configuration of the control device 6 and the storage device 7 will be explained by referring to FIG. 3.

As shown in FIG. 3A, the control device 6 is constituted by a computer and the computer has a processor 61 and a memory 62. In the memory 62, a program that causes the computer to function as the vehicle position detecting unit 11, the traveling direction detecting unit 12, the circular intersection detecting unit 13, the distance detecting unit 14, the first distance determining unit 21, the first notification controlling unit 22, the second distance determining unit 23, the experience value determining unit 24, the second notification controlling unit 25, the passage determining unit 26, and the experience value calculating unit 27 is stored. The processor 61 reads and executes the program stored in the memory 62 to implement the functions of the vehicle position detecting unit 11, the traveling direction detecting unit 12, the circular intersection detecting unit 13, the distance detecting unit 14, the first distance determining unit 21, the first notification controlling unit 22, the second distance determining unit 23, the experience value determining unit 24, the second notification controlling unit 25, the passage determining unit 26, and the experience value calculating unit 27.

Further, the storage device 7 is constituted by a memory 63. The functions of the map data storage unit 31, the traffic rule storage unit 32, and the experience value storage unit 33 are implemented by the memory 63.

As the processor 61, for example, a central processing unit (CPU), a graphics processing unit (GPU), a microprocessor, a microcontroller, or a digital signal processor (DSP) is used. As each of the memories 62 and 63, for example, a semiconductor memory, such as a random access memory (RAM), a read only memory (ROM), a flash memory, an erasable programmable read only memory (EPROM), or an electrically erasable programmable read-only memory (EEPROM), a magnetic disc, an optical disc, or a magneto-optical disc is used.

As an alternative, as shown in FIG. 3B, the functions of the vehicle position detecting unit 11, the traveling direction detecting unit 12, the circular intersection detecting unit 13, the distance detecting unit 14, the first distance determining unit 21, the first notification controlling unit 22, the second distance determining unit 23, the experience value determining unit 24, the second notification controlling unit 25, the passage determining unit 26, and the experience value calculating unit 27 may be implemented by a processing circuit 64 for dedicated use. As the processing circuit 64, for example, an application specific integrated circuit (ASIC), a programmable logic device (PLD), a field-programmable gate array (FPGA), a system-on-a-chip (SoC), ora system large-Scale integration (LSI) is used.

As an alternative, a part of the functions of the vehicle position detecting unit 11, the traveling direction detecting unit 12, the circular intersection detecting unit 13, the distance detecting unit 14, the first distance determining unit 21, the first notification controlling unit 22, the second distance determining unit 23, the experience value determining unit 24, the second notification controlling unit 25, the passage determining unit 26, and the experience value calculating unit 27 may be implemented by the processor 61 and the memory 62, and the remaining functions thereof may be implemented by the processing circuit 64.

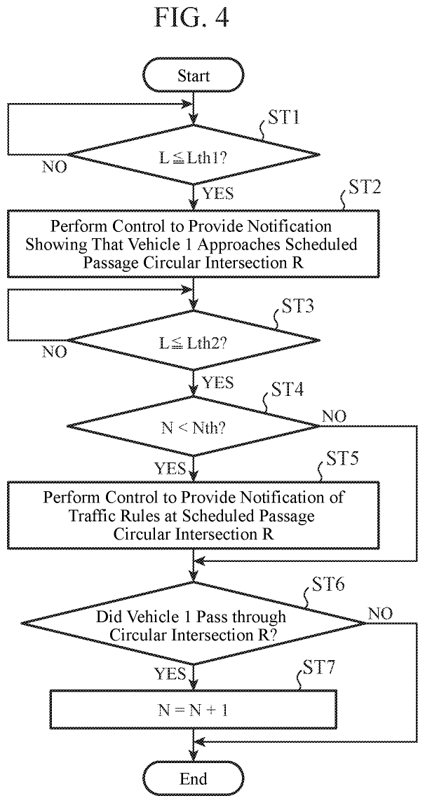

Next, the operation of the control device 6 will be explained by referring to a flowchart of FIG. 4, focusing on the operation of the second control unit 28.

When a to-be-passed-through circular intersection R is present (i.e., when the circular intersection information shows the position, the type, and so on of a to-be-passed-through circular intersection R), the second control unit 28 performs processes of steps ST1 to ST7 described below. In the course of the processing shown in FIG. 4, when there occurs a transition from a state in which a to-be-passed-through circular intersection R is present to a state in which no to-be-passed-through circular intersection R is present (i.e., when there occurs a transition from a state in which the circular intersection information shows the position, the type, and so on of a to-be-passed-through circular intersection R to a state in which the circular intersection information shows that no to-be-passed-through circular intersection R is present) because of a change of the traveling direction of the vehicle 1, or another reason, subsequent processes are canceled.

First, in step ST1, the first distance determining unit 21 acquires the distance information generated by the distance detecting unit 14, and determines whether or not the distance L is equal to or less than the threshold value Lth1. The process of step ST1 is repeatedly performed until the distance L becomes equal to or less than the threshold value Lth1. When the distance L becomes equal to or less than the threshold value Lth1 (“YES” in step ST1), the processing of the second control unit 28 proceeds to step ST2.

Then, in step ST2, the first notification controlling unit 22 performs control to notify the user currently driving the vehicle 1 that the vehicle 1 approaches the to-be-passed-through circular intersection R. Concretely, for example, the first notification controlling unit 22 performs at least one of control to display the first notification image by the display device 4 and control to output the first notification sound by the sound output device 5.

Then, in step ST3, the second distance determining unit 23 acquires the distance information generated by the distance detecting unit 14, and determines whether or not the distance L is equal to or less than the threshold value Lth2. The process of step ST3 is repeatedly performed until the distance L becomes equal to or less than the threshold value Lth2. When the distance L becomes equal to or less than the threshold value Lth2 (“YES” in step ST3), the processing of the second control unit 28 proceeds to step ST4.

Then, in step ST4, the experience value determining unit 24 acquires the experience value N stored in the experience value storage unit 33, and determines whether or not the experience value N is less than the threshold value Nth.

When it is determined that the experience value N is less than the threshold value Nth (“YES” in step ST4), the second notification controlling unit 25, in step ST5, performs control to notify the user currently driving the vehicle 1 of the traffic rules at the to-be-passed-through circular intersection R. Concretely, for example, the second notification controlling unit 25 performs at least one of control to display the second notification image by the display device 4 and control to output the second notification sound by the sound output device 5. On the other hand, when it is determined that the experience value N is equal to or greater than the threshold value Nth (“NO” in step ST4), the process of step ST5 is skipped.

Then, in step ST6, the passage determining unit 26 acquires the vehicle position information generated by the vehicle position detecting unit 11 and the circular intersection information generated by the circular intersection detecting unit 13, and determines whether the vehicle 1 passed through the circular intersection R.

When it is determined that the vehicle 1 passed through the circular intersection R (“YES” in step ST6), the experience value calculating unit 27, in step ST7, increments the experience value N. The experience value calculating unit 27 updates the experience value N stored in the experience value storage unit 33 by storing the incremented experience value N in the experience value storage unit 33. On the other hand, when it is determined that the vehicle 1 did not pass through the circular intersection R (“NO” in step ST6), the process of step ST7 is skipped.

The vehicle position detecting unit 11 may detect the vehicle position by using, instead of the satellite navigation, so-called “autonomous navigation.” More specifically, the vehicle position detecting unit 11 may detect the vehicle position by using an output signal outputted by a sensor disposed in the vehicle 1 (e.g., the gyro sensor 3). As an alternative, the vehicle position detecting unit 11 may detect the vehicle position by executing a combination of the satellite navigation and the autonomous navigation.

Further, the storage device 7 may be disposed in a server device (not illustrated) outside the vehicle 1. The control device 6 may be capable of performing communications with the server device via a computer network (not illustrated) like the Internet.

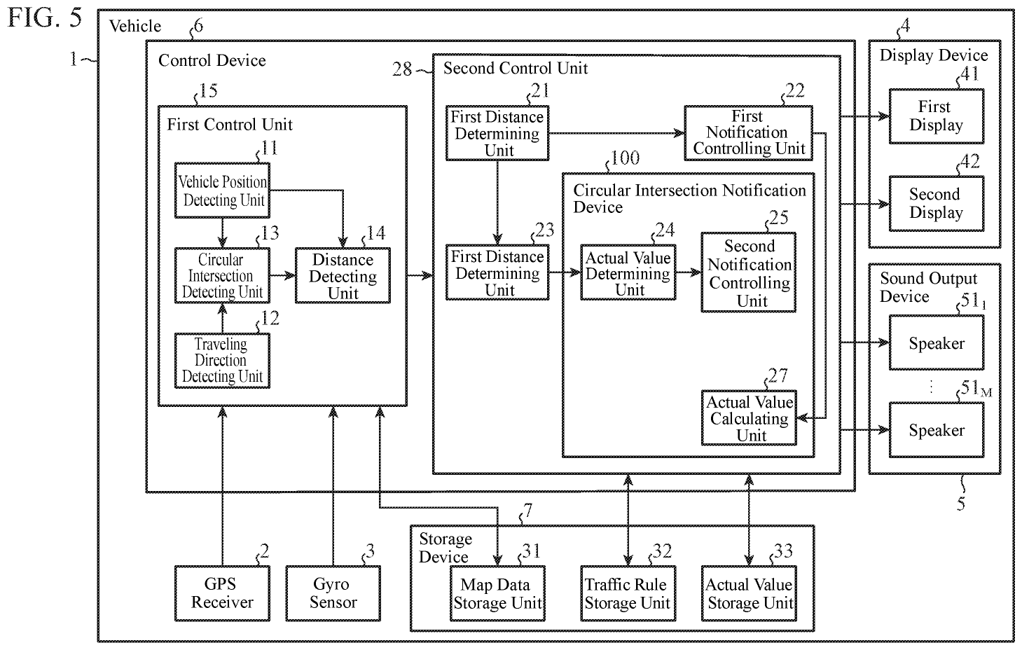

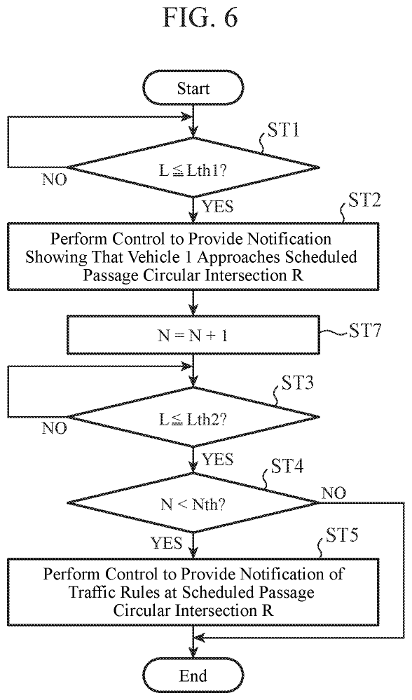

Further, the experience value calculating unit 27 may count the number of times of notification made by the first notification controlling unit 22 (i.e., the number of times of notification showing that the vehicle 1 approached the circular intersection) instead of counting the number of times of passage of the vehicle 1 through the circular intersection. The experience value calculating unit 27 may calculate an experience value N of the number of times of notification instead of calculating the experience value N of the number of times of passage. A block diagram in this case is shown in FIG. 5, and a flowchart in this case is shown in FIG. 6. As shown in FIG. 5, the passage determining unit 26 is not required. As shown in FIG. 6, the process of step ST6 is not required and the process of step ST7 is performed between those of steps ST2 and ST3.

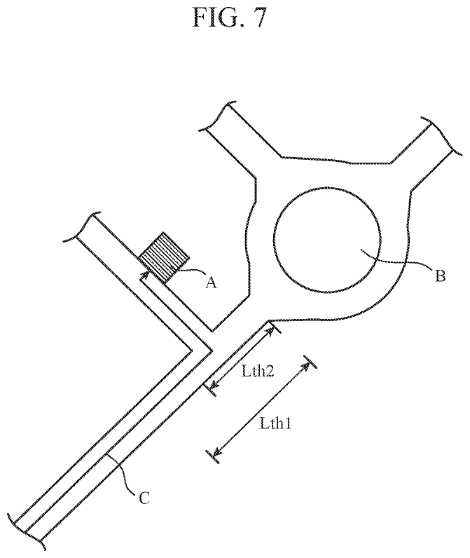

For example, it is assumed that, as shown in FIG. 7, a circular intersection (B in the figure) is located near the home or the place of work (A in the figure) of the user of the vehicle 1, and the user's commuting route (C in the figure) does not pass through the circular intersection B. In this situation, in case that the experience value calculating unit 27 counts the number of times of passage of the vehicle 1 through each circular intersection, the experience value N does not increase due to the commuting. Therefore, every time when the commuting is performed, the traffic rules at the circular intersection B is notified. On the other hand, in the case in which the experience value calculating unit 27 counts the number of times of notification made by the first notification controlling unit 22, the experience value N is increased due to the commuting. Because the experience value N becomes equal to or greater than the threshold value Nth with increase in the experience value N, it is possible to prevent a notification of the traffic rules at the circular intersection B. As a result, unnecessary notifications provided to users can be suppressed.

Further, the control device 6 may freely set the necessity or unnecessity of the performance of the processing shown in FIG. 4 or 6 through an operation inputted to an operation input device (not illustrated) such as a touch panel or a hardware key. Namely, the circular intersection notification device 100 may freely set the switching on and off of each of notifications made by the first notification controlling unit 22 and the second notification controlling unit 25. As a result, unnecessary notifications to the user currently driving the vehicle 1 can be prevented.

Further, in step ST5, the second notification controlling unit 25 may make the notification mode of the traffic rules at the to-be-passed-through circular intersection R differ depending on the experience value N. As a result, a balance between the presentation of the traffic rules by notification and reduction in annoyance that the user feels because of notification can be improved.

For example, a reference value Nr that is a value to be compared with the experience value N is preset in the second notification controlling unit 25. The reference value Nr is set to be less than the threshold value Nth. When the experience value determining unit 24 determines that the experience value N is less than the threshold value Nth, the second notification controlling unit 25 acquires the experience value N stored in the experience value storage unit 33. The second notification controlling unit 25 determines whether or not the acquired experience value N is less than the reference value Nr.

When it is determined that the experience value N is less than the reference value Nr (i.e., when the experience value N is equal to or greater than 0 and is less than Nr), the second notification controlling unit 25 causes each of the first and second displays 41 and 42 to display the second notification image and also causes the sound output device 5 to output the second notification sound.

On the other hand, when it is determined that the experience value N is equal to or greater than the reference value Nr (i.e., when the experience value N is equal to or greater than Nr and is less than Nth), the second notification controlling unit 25 causes each of the first and second displays 41 and 42 to display the second notification image and also causes the sound output device 5 to output a sound showing a smaller amount of information than that shown by the second notification sound (referred to as a “simple notification sound” hereinafter, and the simple notification sound shows that, for example, a to-be-passed-through circular intersection R is present ahead of the vehicle 1).

As an alternative, when it is determined that the experience value N is equal to or greater than the reference value Nr, the second notification controlling unit 25 causes only the first display 41 to display the second notification image and also causes the sound output device 5 to output the simple notification sound.

As an alternative, when it is determined that the experience value N is equal to or greater than the reference value Nr, the second notification controlling unit 25 causes only the second display 42 to display the second notification image and also causes the sound output device 5 to output the simple notification sound.

As an alternative, when it is determined that the experience value N is equal to or greater than the reference value Nr, the second notification controlling unit 25 causes each of the first and second displays 41 and 42 to display the second notification image. At this time, the second notification controlling unit 25 neither causes the sound output device 5 to output the second notification sound nor causes the sound output device 5 to output the simple notification sound.

As an alternative, when it is determined that the experience value N is equal to or greater than the reference value Nr, the second notification controlling unit 25 causes only the first display 41 to display the second notification image. At this time, the second notification controlling unit 25 neither causes the sound output device 5 to output the second notification sound nor causes the sound output device 5 to output the simple notification sound.

As an alternative, when it is determined that the experience value N is equal to or greater than the reference value Nr, the second notification controlling unit 25 causes only the second display 42 to display the second notification image. At this time, the second notification controlling unit 25 neither causes the sound output device 5 to output the second notification sound nor causes the sound output device 5 to output the simple notification sound.

Further, the experience value calculating unit 27 may count either the above-described number of times of passage or the above-described number of times of notification for each type of circular intersection, to calculate an experience value N for each type of circular intersection. For example, in a case in which circular intersections are classified into O types, the experience value calculating unit 27 calculates O experience values N₁ to N₀ in one-to-one correspondence with the O types of circular intersections (O is an integer equal to or greater than 2). In this case, in step ST4, the experience value determining unit 24 acquires the experience value N corresponding to the type of the to-be-passed-through circular intersection R out of the O experience values N₁ to N₀ stored in the experience value storage unit 33, and determines whether or not the acquired experience value N is less than the threshold value Nth. As a result, for example, when the user currently driving the vehicle 1 does not have much experience in driving through a specific type of circular intersection, a notification of the traffic rules at the specific type of circular intersection can be provided.

Further, the experience value calculating unit 27 may count either the above-described number of times of passage or the above-described number of times of notification for each of the positions of circular intersections (i.e., for each of circular intersections), to calculate an experience value N for each of the positions of the circular intersections (i.e., for each of individual circular intersections). For example, the experience value calculating unit 27 calculates P experience values N₁ to N_{P} in one-to-one correspondence with P circular intersections (P is an integer equal to or greater than 2). In this case, in step ST4, the experience value determining unit 24 acquires the experience value N corresponding to the position of the to-be-passed-through circular intersection R out of the P experience values N₁ to N_{P} stored in the experience value storage unit 33, and determines whether or not the acquired experience value N is less than the threshold value Nth.

Further, in a case in which the vehicle 1 is shared by two or more users, the control device 6 may have a function of identifying the user currently driving the vehicle 1 out of the two or more users (referred to as an “personal identification function” hereinafter). Concretely, for example, the control device 6 identifies the user currently driving the vehicle 1 by using a driver monitoring system (not illustrated) for the vehicle 1. Or, for example, the control device 6 identifies the user currently driving the vehicle 1 by performing pairing based on the BLUETOOTH (registered trademark) standards on a mobile information terminal (not illustrated) carried in the vehicle 1.

Further, in the case in which the control device 6 has the personal identification function, the experience value calculating unit 27 may count either the above-described number of times of passage or the above-described number of times of notification for each user of the vehicle 1, to calculate an experience value N for each user of the vehicle 1. For example, in a case in which the vehicle 1 is shared by Q users, the experience value calculating unit 27 calculates Q experience values N₁ to N_{Q} in one-to-one correspondence with the Q users (Q is an integer equal to or greater than 2). In this case, in step ST4, the experience value determining unit 24 acquires the experience value N corresponding to the user currently driving the vehicle 1, out of the Q experience values N₁ to N_{Q} stored in the experience value storage unit 33, and determines whether or not the acquired experience value Nis less than the threshold value Nth. As a result, a notification of the traffic rules at the to-be-passed-through circular intersection R can be provided for users who do not have much experience in driving through the circular intersection, out of the two or more users. Further, because a notification of the traffic rules at the to-be-passed-through circular intersection R can be prevented from being provided for users who have much experience in driving through the circular intersection, out of the two or more users, unnecessary notifications to users who have much experience in driving through the circular intersection, out of the two or more users, can be prevented.

Further, in the case in which the experience value calculating unit 27 calculates the experience value N for each user, the experience value N calculated by the experience value calculating unit 27 may be transmitted to a server device (not illustrated) by a wireless communication device (not illustrated) disposed in the vehicle 1. Further, the wireless communication device may have a function of receiving the experience value N stored in the server device from the server device, and storing the received experience value N in the experience value storage unit 33. As a result, in a case in which the control device 6 is disposed in each of multiple vehicles including the vehicle 1, the experience value N for each user can be shared by these control devices 6. As a result, when, for example, a specific user changes from one vehicle to another, the count of the experience value N corresponding to the user can be taken over.

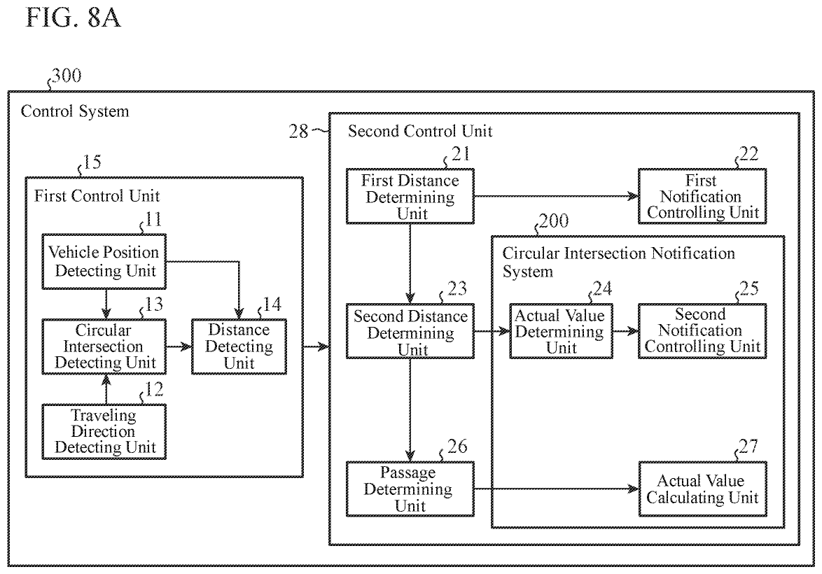

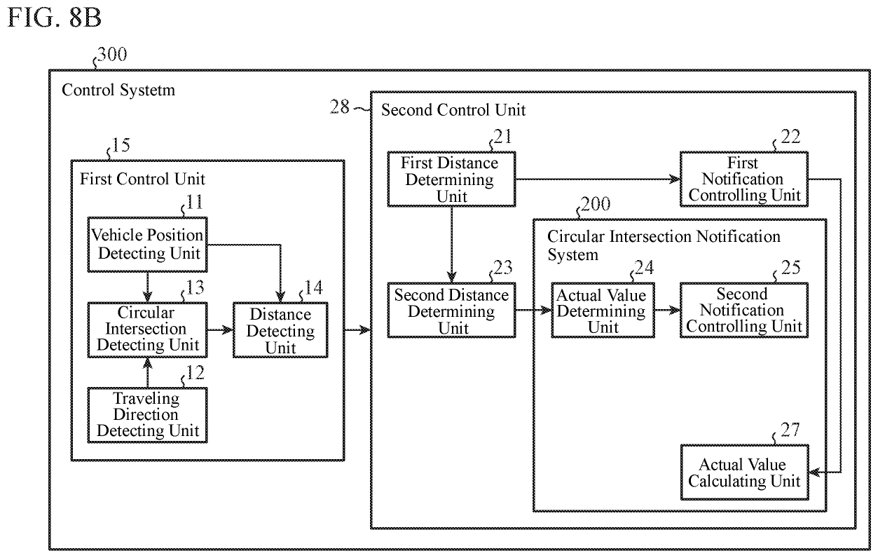

Further, a main part of a circular intersection notification system 200 may be constituted by the experience value determining unit 24, the second notification controlling unit 25, and the experience value calculating unit 27, as shown in FIG. 8A or 8B. Further, amain part of a control system 300 may be constituted by the first control unit 15 and the second control unit 28.

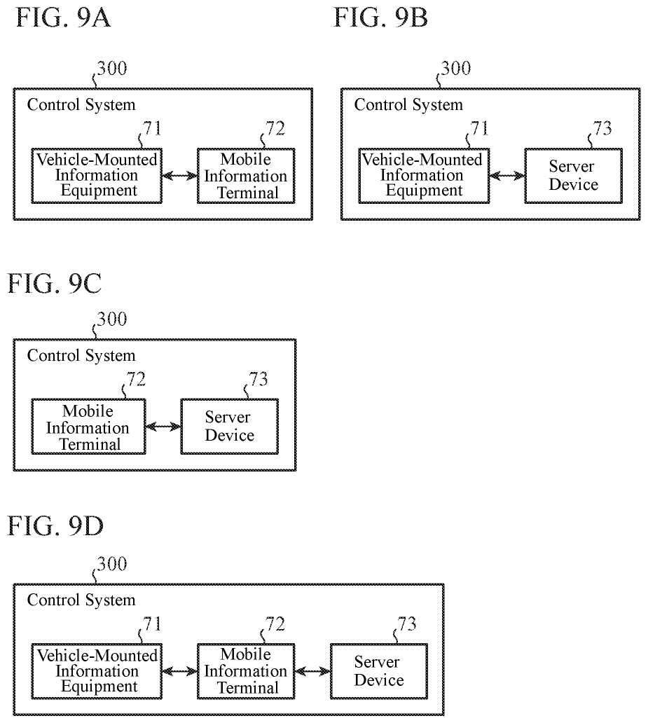

Each of FIG. 9A to FIG. 9D shows the system configuration of the control system 300. As shown in FIG. 9, the control system 300 is constituted by two or more of vehicle-mounted information equipment 71 that can be freely mounted in the vehicle 1, a mobile information terminal 72 that can be freely carried in the vehicle 1, and a server device 73 that can freely communicate with either the vehicle-mounted information equipment 71 or the mobile information terminal 72. The functions of the first control unit 15 and the second control unit 28 should just be implemented by causing two or more of the vehicle-mounted information equipment 71, the mobile information terminal 72, and the server devices 73 to cooperate with one another.

Further, the experience value determining unit 24 may perform a process of determining whether or not the experience value N is equal to or less than the threshold value Nth, instead of the process of determining whether or not the experience value N is less than the threshold value Nth. The meaning of the term “determining whether or not the experience value is less than the threshold value” described in the claims of this application includes not only the process of determining whether or not the experience value N is less than the threshold value Nth, but also the process of determining whether or not the experience value N is equal to or less than the threshold value Nth.

As described above, the circular intersection notification device 100 of Embodiment 1 includes: an experience value calculating unit 27 to calculate an experience value N of either the number of times of passage through a circular intersection or the number of times of notification of an approach to a circular intersection by counting the number of times of passage or the number of times of notification; an experience value determining unit 24 to, when a vehicle 1 approaches a to-be-passed-through circular intersection R through which the vehicle 1 is presumed to pass through, determine whether or not the experience value N calculated by the experience value calculating unit 27 is less than a threshold value Nth; and a notification controlling unit (the second notification controlling unit 25) to, when the experience value determining unit 24 determines that the experience value N is less than the threshold value Nth, perform control to notify a user currently driving the vehicle 1 of traffic rules at the to-be-passed-through circular intersection R. As a result, a notification of the traffic rules at the to-be-passed-through circular intersection R can be provided for users who do not have much experience in driving through the circular intersection. Further, because a notification of the traffic rules to users who have much experience in driving through the circular intersection at the to-be-passed-through circular intersection R can be prevented, unnecessary notifications to users who have much experience in driving through the circular intersection can be prevented.

Further, the experience value calculating unit 27 calculates the experience values N for respective types of circular intersections by counting either the number of times of passage or the number of times of notification for each of the types of circular intersections, and, when the vehicle 1 approaches the to-be-passed-through circular intersection R, the experience value determining unit 24 determines whether or not the experience value N corresponding to a type of the to-be-passed-through circular intersection R, out of experience values N calculated by the experience value calculating unit 27, is less than the threshold value Nth. As a result, for example, when the user currently driving the vehicle 1 does not have much experience in driving through a specific type of circular intersection, a notification of the traffic rules at the specific type of circular intersection can be provided.

Further, the experience value calculating unit 27 calculates experience values N for respective positions of circular intersections by counting either the number of times of passage or the number of times of notification for each of the positions of the circular intersections, and, when the vehicle 1 approaches the to-be-passed-through circular intersection R, the experience value determining unit 24 determines whether or not the experience value N corresponding to a position of the to-be-passed-through circular intersection R, out of experience values N calculated by the experience value calculating unit 27, is less than the threshold value Nth. As a result, the experience value N can be calculated for each circular intersection by counting either the number of times of passage or the number of times of notification for each circular intersection.

Further, the vehicle 1 is shared by two or more users, the experience value calculating unit 27 calculates experience values N for respective users of the vehicle 1 by counting either the number of times of passage or the number of times of notification for each user of the vehicle 1, and, when the vehicle 1 approaches the to-be-passed-through circular intersection R, the experience value determining unit 24 determines whether or not the experience value N corresponding to a user currently driving the vehicle 1, out of experience values N calculated by the experience value calculating unit 27, is less than the threshold value Nth. As a result, a notification of the traffic rules at the to-be-passed-through circular intersection R can be provided for users who do not have much experience in driving through the circular intersection, out of the two or more users. Further, because a notification of the traffic rules to users who have much experience in driving through the circular intersection, out of the two or more users, at the to-be-passed-through circular intersection R can be prevented, unnecessary notifications to users who have much experience in driving through the circular intersection, out of the two or more users, can be suppressed.

Further, the notification controlling unit (the second notification controlling unit 25) performs the control to notify the user of traffic rules at the to-be-passed-through circular intersection R to be different depending on the experience value N calculated by the experience value calculating unit 27. As a result, a balance between the presentation of the traffic rules using notification and reduction in annoyance that the user feels due to notification can be improved.

Further, in the circular intersection notification device 100, the control to notify the user of traffic rules at the to-be-passed-through circular intersection can be set to be switched-on or switched-off freely. As a result, unnecessary notifications to the user currently driving the vehicle 1 can be prevented.

Further, the circular intersection notification system 200 of Embodiment 1 includes: an experience value calculating unit 27 to calculate an experience value N of either the number of times of passage through a circular intersection or the number of times of notification of an approach to a circular intersection by counting the number of times of passage or the number of times of notification; an experience value determining unit 24 to, when a vehicle 1 approaches a to-be-passed-through circular intersection R through which the vehicle 1 is presumed to pass through, determine whether or not the experience value N calculated by the experience value calculating unit 27 is less than a threshold value Nth; and a notification controlling unit (the second notification controlling unit 25) to, when the experience value determining unit 24 determines that the experience value Nis less than the threshold value Nth, perform control to notify a user currently driving the vehicle 1 of traffic rules at the to-be-passed-through circular intersection R. As a result, the same advantages as the above-described advantages provided by the circular intersection notification device 100 can be provided.

Further, the circular intersection notification method of Embodiment 1 includes: a step ST7 of, by an experience value calculating unit 27, calculating an experience value N of either the number of times of passage through a circular intersection or the number of times of notification of an approach to a circular intersection by counting the number of times of passage or the number of times of notification; a step ST4 of, by an experience value determining unit 24, when a vehicle 1 approaches a to-be-passed-through circular intersection R through which the vehicle 1 is presumed to pass through, determining whether or not the experience value N calculated by the experience value calculating unit 27 is less than a threshold value Nth; and a step ST5 of, by a notification controlling unit (the second notification controlling unit 25), when the experience value determining unit 24 determines that the experience value N is less than the threshold value Nth, performing control to notify a user currently driving the vehicle 1 of traffic rules at the to-be-passed-through circular intersection R. As a result, the same advantages as the above-described advantages provided by the circular intersection notification device 100 can be provided.

### Embodiment 2

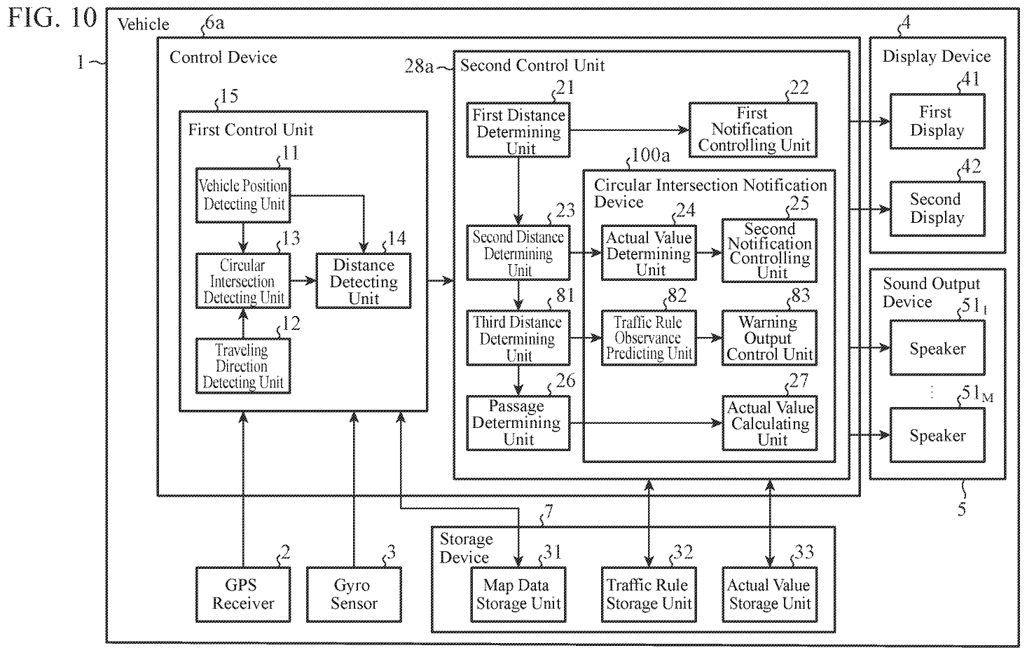

FIG. 10 is a block diagram showing a main part of a control device including a circular intersection notification device according to Embodiment 2. Referring to FIG. 10, the circular intersection notification device 100a of Embodiment 2 will be explained focusing on an example in which the circular intersection notification device is disposed in the control device 6a in a vehicle 1. In FIG. 10, the same blocks as those shown in FIG. 1 are denoted by the same reference signs, and an explanation of the blocks will be omitted hereinafter.

A threshold value Lth3 that is a value to be compared with a distance L is preset in a third distance determining unit 81. The threshold value Lth3 is set to be less than a threshold value Lth2. The third distance determining unit 81 acquires distance information generated by a distance detecting unit 14 when a second distance determining unit 23 determined that the distance L is equal to or less than the threshold value Lth2. The third distance determining unit 81 determines whether or not the distance L is equal to or less than the threshold value Lth3 by using the acquired distance information.

When the third distance determining unit 81 determines that the distance L is equal to or less than the threshold value Lth3, a traffic rule observance predicting unit 82 acquires traffic rule information showing the traffic rules at a to-be-passed-through circular intersection R from a traffic rule storage unit 32. The traffic rule observance predicting unit 82 predicts whether or not a traffic rule when the vehicle 1 enters the to-be-passed-through circular intersection R (referred to as a “traffic rule at the time of entry” hereinafter) will be observed by using the acquired traffic rule information.

Concretely, for example, it is assumed that the to-be-passed-through circular intersection R is a circular intersection that vehicles must enter by making a left-hand turn. The traffic rule observance predicting unit 82 acquires information showing the lighting state of a direction indicator (not illustrated) disposed in the vehicle 1. When a direction indicator for a left-hand turn is lit, the traffic rule observance predicting unit 82 predicts that the traffic rule at the time of entry with respect to right-hand/left-hand turns will be observed. Otherwise (e.g., when a direction indicator for a right-hand turn is lit), the traffic rule observance predicting unit 82 predicts that the traffic rule at the time of entry with respect to right-hand/left-hand turns will not be observed.

Further, for example, it is assumed that the to-be-passed-through circular intersection R is a circular intersection that vehicles must stop or slow down at the time of entry. The traffic rule observance predicting unit 82 acquires information showing the traveling speed of the vehicle 1. When the traveling speed of the vehicle 1 is less than a predetermined speed, the traffic rule observance predicting unit 82 predicts that the traffic rule at the time of entry with respect to the traveling speed will be observed. Otherwise (i.e., when the traveling speed of the vehicle 1 is equal to or greater than the predetermined speed), the traffic rule observance predicting unit 82 predicts that the traffic rule at the time of entry with respect to the traveling speed will not be observed.

When the traffic rule observance predicting unit 82 predicts that the traffic rule at the time of entry will not be observed, a warning output control unit 83 performs control to output a warning to the user currently driving the vehicle 1.

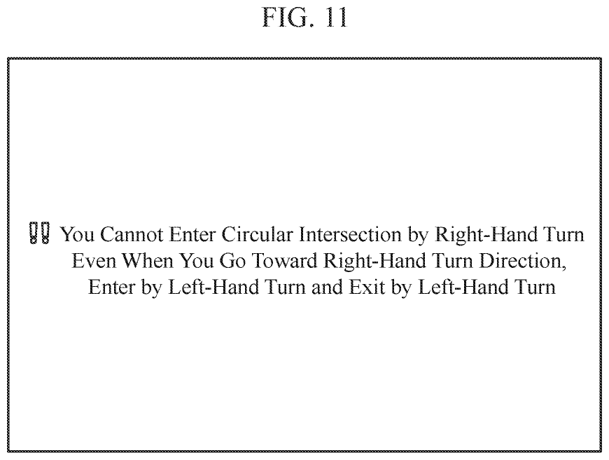

Concretely, for example, the warning output control unit 83 performs at least one of control to display an image for warning (referred to as a “warning image” hereinafter) by a display device 4 and control to output a sound for warning (referred to as a “warning sound” hereinafter) by a sound output device 5. FIG. 11 shows an example of the warning image.

A passage determining unit 26 determines whether the vehicle 1 passed through the circular intersection R after when the third distance determining unit 81 determined that the distance L is equal to or less than the threshold value Lth3.

A second control unit 28a is constituted by a first distance determining unit 21, a first notification controlling unit 22, the second distance determining unit 23, an experience value determining unit 24, a second notification controlling unit 25, the passage determining unit 26, an experience value calculating unit 27, the third distance determining unit 81, the traffic rule observance predicting unit 82, and the warning output control unit 83. A main part of the circular intersection notification device 100a is constituted by the experience value determining unit 24, the second notification controlling unit 25, the experience value calculating unit 27, the traffic rule observance predicting unit 82, and the warning output control unit 83. A main part of the control device 6a is constituted by the first control unit 15 and the second control unit 28a.

Because the hardware configuration of the control device 6a is the same as that explained by referring to FIG. 3 in Embodiment 1, an illustration and an explanation of the hardware configuration will be omitted hereinafter. Namely, the functions of the first distance determining unit 21, the first notification controlling unit 22, the second distance determining unit 23, the experience value determining unit 24, the second notification controlling unit 25, the passage determining unit 26, the experience value calculating unit 27, the third distance determining unit 81, the traffic rule observance predicting unit 82, and the warning output control unit 83 may be implemented by either a processor 61 and a memory 62, or a processing circuit 64.

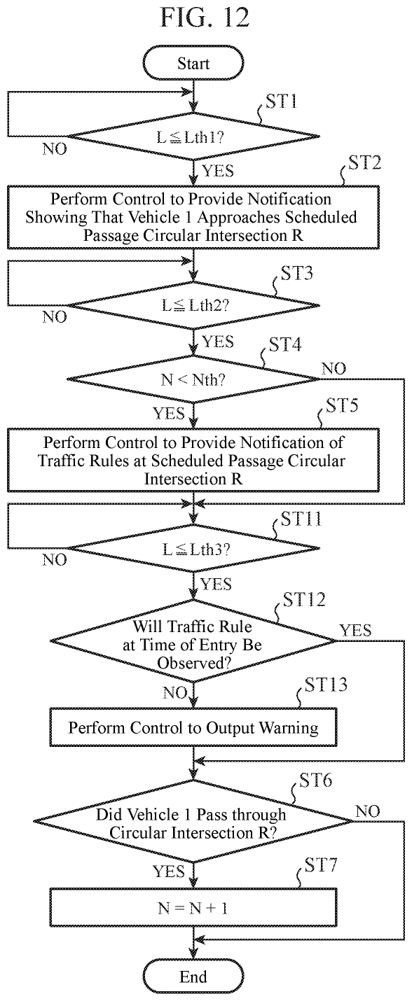

Next, referring to a flowchart of FIG. 12, the operation of the control device 6a will be explained focusing on the operation of the second control unit 28a. In FIG. 12, the same steps as those shown in FIG. 4 are denoted by the same reference signs, and an explanation of the steps will be omitted hereinafter.

When a to-be-passed-through circular intersection R is present (i.e., when the circular intersection information shows the position, the type, and so on of a to-be-passed-through circular intersection R), the second control unit 28a performs processes of steps ST1 to ST7 and ST11 to ST13 described below. In the course of the processing shown in FIG. 12, when there occurs a transition from a state in which a to-be-passed-through circular intersection R is present to a state in which no to-be-passed-through circular intersection R is present because of a change of the traveling direction of the vehicle 1, or another reason (i.e., when there occurs a transition from a state in which the circular intersection information shows the position, the type, and so on of a to-be-passed-through circular intersection R to a state in which the circular intersection information shows that no to-be-passed-through circular intersection R is present), subsequent processes are canceled.

Because the details of the processes of steps ST1 to ST5 are the same as those explained by referring to FIG. 4 in Embodiment 1, an explanation of the processes will be omitted hereinafter.

Then, in step ST11, the third distance determining unit 81 acquires the distance information generated by the distance detecting unit 14, and determines whether or not the distance L is equal to or less than the threshold value Lth3. The process of step ST11 is repeatedly performed until the distance L becomes equal to or less than the threshold value Lth3. When the distance L becomes equal to or less than the threshold value Lth3 (“YES” in step ST11), the processing of the second control unit 28a proceeds to step ST12.

Then, in step ST12, the traffic rule observance predicting unit 82 acquires the traffic rule information showing the traffic rules at the to-be-passed-through circular intersection R from the traffic rule storage unit 32, and predicts whether or not the traffic rule at the time of entry will be observed.

When it is predicted that the traffic rule at the time of entry will not be observed (“NO” in step ST12), the warning output control unit 83 performs control to output a warning to the user currently driving the vehicle 1 in step ST13. Concretely, for example, the warning output control unit 83 performs at least one of control to display a warning image by the display device 4 and control to output a warning sound by the sound output device 5. On the other hand, when it is predicted that the traffic rule at the time of entry will be observed (“YES” in step ST12), the process of step ST13 is skipped.

Then, the processing of the second control unit 28a proceeds to step ST6. Because the details of the processes of steps ST6 and ST7 are the same as those explained by referring to FIG. 4 in Embodiment 1, an explanation of the processes will be omitted hereinafter.

By thus predicting whether or not the traffic rule at the time of entry will be observed before the vehicle 1 enters the to-be-passed-through circular intersection R, and outputting a warning when it is predicted that the traffic rule at the time of entry will not be observed, the vehicle 1 can be prevented from breaking the traffic rule at the time of entry.

As the circular intersection notification device 100a, the same various variants as those explained in Embodiment 1, i.e., the same various variants as those of the circular intersection notification device 100 can be adopted.

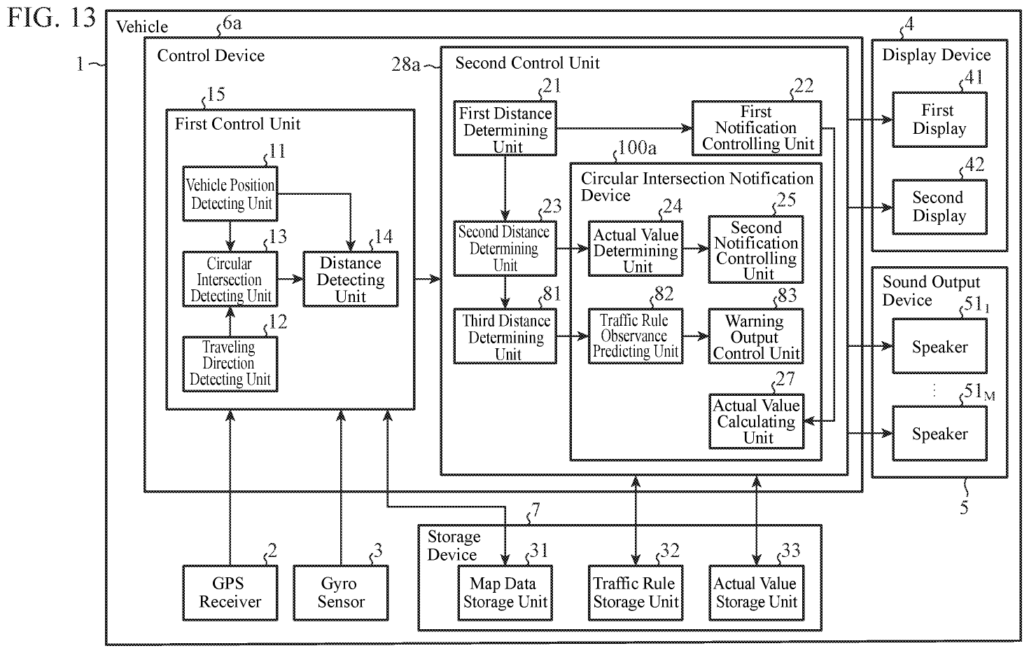

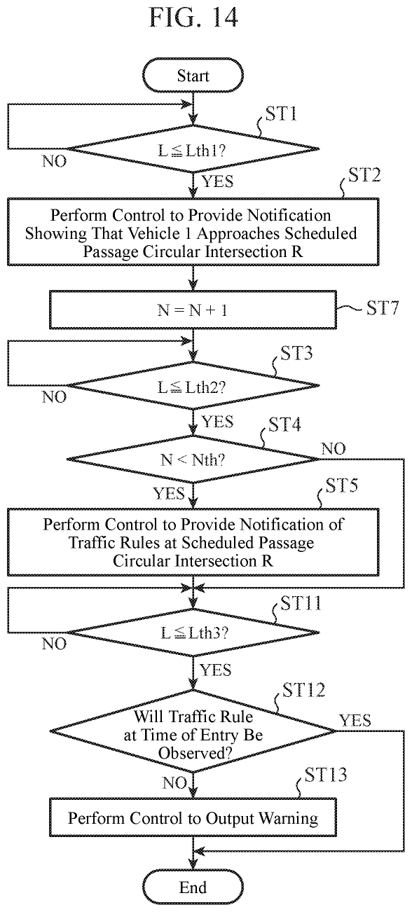

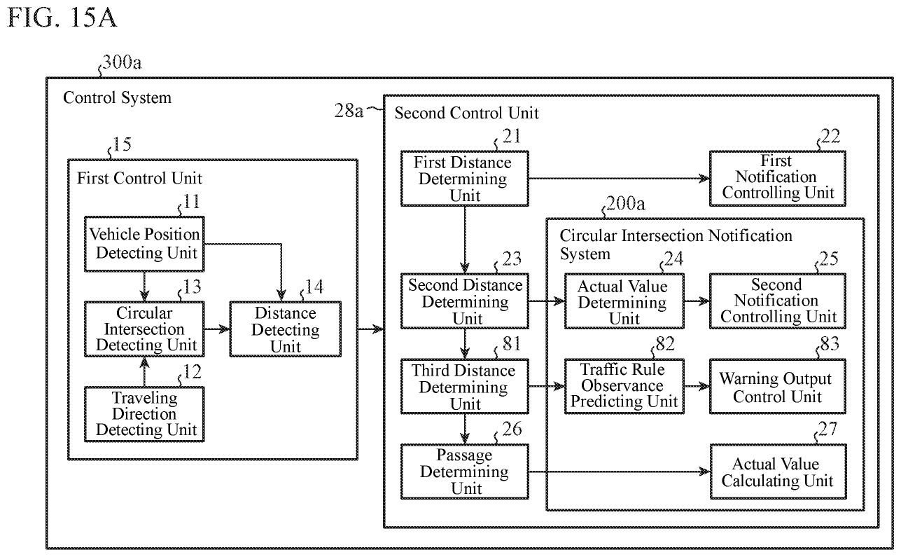

For example, the experience value calculating unit 27 may count the number of times of notification made by the first notification controlling unit 22 (i.e., the number of times of notification showing that the vehicle 1 approached a circular intersection) instead of counting the number of times of passage of the vehicle 1 through a circular intersection. The experience value calculating unit 27 may calculate an experience value N of the number of times of notification instead of calculating an experience value N of the number of times of passage. A block diagram in this case is shown in FIG. 13, and a flowchart in this case is shown in FIG. 14. As shown in FIG. 13, the passage determining unit 26 is not required. As shown in FIG. 14, the process of step ST6 is not required and the process of step ST7 is performed between those of steps ST2 and ST3.

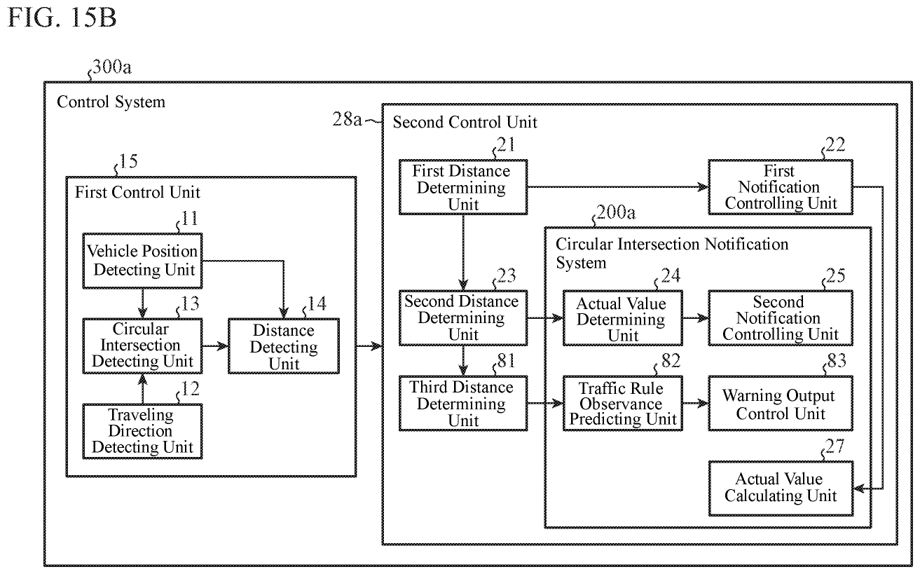

Further, as shown in FIG. 15A or 15B, a main part of a circular intersection notification system 200a may be constituted by the experience value determining unit 24, the second notification controlling unit 25, the experience value calculating unit 27, the traffic rule observance predicting unit 82, and the warning output control unit 83. Further, a main part of a control system 300a may be constituted by the first control unit 15 and the second control unit 28a.

Because the system configuration of the control system 300a is the same as that explained by referring to FIG. 9 in Embodiment 1, an illustration and an explanation of the system configuration will be omitted hereinafter. Namely, the functions of the first control unit 15 and the second control unit 28a should just be implemented by causing two or more of vehicle-mounted information equipment 71, a mobile information terminal 72, and a server device 73 to cooperate with one another.

As described above, the circular intersection notification device 100a of Embodiment 2 includes: a traffic rule observance predicting unit 82 to, when the vehicle 1 approaches the to-be-passed-through circular intersection R, predict whether or not a traffic rule when the vehicle 1 enters the to-be-passed-through circular intersection R will be observed; and a warning output control unit 83 to perform control to output a warning to a user currently driving the vehicle 1 when the traffic rule observance predicting unit 82 predicts that the traffic rule when the vehicle 1 enters the to-be-passed-through circular intersection R will not be observed. As a result, the vehicle 1 can be prevented from breaking the traffic rule at the time of entry.

It is to be understood that any combination of two or more of the above-described embodiments can be made, various changes can be made in any component according to any one of the above-described embodiments, and any component according to any one of the above-described embodiments can be omitted within the scope of the present disclosure.

### INDUSTRIAL APPLICABILITY

The circular intersection notification device of the present disclosure is suitable for use in, for example, vehicles to be delivered to countries or areas in which circular intersections are constructed.

### REFERENCE SIGNS LIST

1 vehicle, 2 GPS receiver, 3 gyro sensor, 4 display device, 5 sound output device, 6, 6a control device, 7 storage device, 11 vehicle position detecting unit, 12 traveling direction detecting unit, 13 circular intersection detecting unit, 14 distance detecting unit, 15 first control unit, 21 first distance determining unit, 22 first notification controlling unit, 23 second distance determining unit, 24 experience value determining unit, 25 second notification controlling unit, 26 passage determining unit, 27 experience value calculating unit, 28, 28a second control unit, 31 map data storage unit, 32 traffic rule storage unit, 33 experience value storage unit, 41 first display, 42 second display, 51₁ to 51_{M} speaker, 61 processor, 62 memory, 63 memory, 64 processing circuit, 71 vehicle-mounted information equipment, 72 mobile information terminal, 73 server device, 81 third distance determining unit, 82 traffic rule observance predicting unit, 83 warning output control unit, 100, 100a circular intersection notification device, 200, 200a circular intersection notification system, and 300, 300a control system.

1. A circular intersection notification device comprising processing circuitry
to calculate an experience value of either the number of times of passage through a circular intersection or the number of times of notification of an approach to a circular intersection by counting the number of times of passage or the number of times of notification;
to, when a vehicle approaches a to-be-passed-through circular intersection through which the vehicle is presumed to pass through, determine whether or not the experience value is less than a threshold value; and
to, when the experience value is determined to be less than the threshold value, perform control to notify a user currently driving the vehicle of traffic rules at the to-be-passed-through circular intersection.

2. The circular intersection notification device according to claim 1, wherein the processing circuitry calculates experience values for respective types of circular intersections by counting either the number of times of passage or the number of times of notification for each of the types of the circular intersections, and,
when the vehicle approaches the to-be-passed-through circular intersection, the processing circuitry determines whether or not the experience value corresponding to a type of the to-be-passed-through circular intersection, out of experience values, is less than the threshold value.

3. The circular intersection notification device according to claim 1, wherein the processing circuitry calculates experience values for respective positions of circular intersections by counting either the number of times of passage or the number of times of notification for each of the positions of the circular intersections, and,
when the vehicle approaches the to-be-passed-through circular intersection, the processing circuitry determines whether or not the experience value corresponding to a position of the to-be-passed-through circular intersection, out of experience values, is less than the threshold value.

4. The circular intersection notification device according to claim 1, wherein the vehicle is shared by two or more users,
the processing circuitry calculates experience values for respective users of the vehicle by counting either the number of times of passage or the number of times of notification for each user of the vehicle, and,
when the vehicle approaches the to-be-passed-through circular intersection, the processing circuitry determines whether or not the experience value corresponding to a user currently driving the vehicle, out of the experience values, is less than the threshold value.

5. The circular intersection notification device according to claim 1, wherein the processing circuitry performs processing
to, when the vehicle approaches the to-be-passed-through circular intersection, predict whether or not a traffic rule when the vehicle enters the to-be-passed-through circular intersection will be observed; and
to perform control to output a warning to a user currently driving the vehicle when it is predicted that the traffic rule when the vehicle enters the to-be-passed-through circular intersection will not be observed.

6. The circular intersection notification device according to claim 1, wherein the processing circuitry performs the control to notify the user of traffic rules at the to-be-passed-through circular intersection to be different depending on the experience value.

7. The circular intersection notification device according to claim 1, wherein the control to notify the user of traffic rules at the to-be-passed-through circular intersection can be set to be switched-on or switched-off freely.

8. A circular intersection notification system comprising processing circuitry
to calculate an experience value of either the number of times of passage through a circular intersection or the number of times of notification of an approach to a circular intersection by counting the number of times of passage or the number of times of notification;
to, when a vehicle approaches a to-be-passed-through circular intersection through which the vehicle is presumed to pass through, determine whether or not the experience value is less than a threshold value; and
to, when the experience value is determined to be less than the threshold value, perform control to notify a user currently driving the vehicle of traffic rules at the to-be-passed-through circular intersection.

9. A circular intersection notification method comprising:
calculating an experience value of either the number of times of passage through a circular intersection or the number of times of notification of an approach to a circular intersection by counting the number of times of passage or the number of times of notification;
when a vehicle approaches a to-be-passed-through circular intersection through which the vehicle is presumed to pass through, determining whether or not the experience value is less than a threshold value; and
the experience value is determined to be less than the threshold value, performing control to notify a user currently driving the vehicle of traffic rules at the to-be-passed-through circular intersection.
